(19) United States
(12) Patent Application Publication
(10) Pub. No.: US 2016/0173542 A1
(43) Pub. Date: Jun. 16, 2016

(54) System and Methods for Creating and Updating Virtual Groups and Locating Other Groups All in Real Time

(71) Applicant: Nicolas Wieczorek, Highland Park, IL (US)

(72) Inventor: Nicolas Wieczorek, Highland Park, IL (US)

(21) Appl. No.: 14/965,384

(22) Filed: Dec. 10, 2015

Related U.S. Application Data
(60) Provisional application No. 62/090,012, filed on Dec. 10, 2014.

(51) Int. Cl. H04L 29/06; H04L 29/08; G06F 3/0484; G06F 3/0482; G06F 17/30; H04L 12/58

(52) U.S. Cl. CPC H04L 65/403; G06F 17/30867; G06F 17/30377; H04L 51/32; G06F 3/04842; G06F 3/0482; H04L 67/306

(57) ABSTRACT

A system and methods for creating, forming or generating one or more virtual groups of individuals' names and information about the individuals, updating or revising the virtual group by adding and removing individuals from the one or more virtual groups or updating information about the groups or individuals, locating other virtual groups of individuals or events using geographical locations and time, connecting with those other virtual groups, and reviewing or rating the groups or events, all in real time, using individual user devices, for example, cellular telephones, computer tablets or personal computers.

### PRIORITY STATEMENT

This application claims the benefit of U.S. Provisional Application 62/090,012 filed Dec. 10, 2014.

### FIELD OF THE INVENTION

The present disclosure relates generally to a system and methods for creating a virtual group, updating the group, locating other virtual groups, and connecting with those other virtual groups, all in real time. More particularly, the disclosure relates to a system and methods for creating, forming or generating a virtual group or cliq of individuals' names and information about the individuals, updating or revising the virtual group by adding and removing individuals from the virtual group or cliq or updating information about the group or individuals, locating other virtual groups of individuals or events using geographical locations and time, connecting with those other virtual groups, and reviewing or rating the groups or events, all in real time, using individual user devices, for example, cellular telephones, computer tablets or personal computers.

### BACKGROUND OF THE INVENTION

Since the time individuals first started meeting with each other, there has always been an issue with finding the right group, along with the right event, location and/or time, or finding other individuals or groups to attend the meeting. Whether for business or for pleasure, the initial meeting details need to be generated, then the meeting participants need to be included and/or deleted from the list, invitations need to be sent, and often the meeting details need to be revised. Then, the meeting participants need to be informed of any changes, including last minute changes. Although certain software programs and applications, such as Microsoft Outlook, Evite and even Facebook may be configured to allow an individual to set up a meeting and send out invitations, and in some instances, revise the meeting plans, the prior art services do not provide all of the necessary functionality for a seamless, real time, interaction between multiple groups, at precise locations and time and/or at events, with follow-up reviews after the meetings, such as rating the event, meeting or other group.

As such, individuals and groups of individuals are left without the real time capability of creating one or more virtual groups, made up of selected and invited individuals, revising the group of individuals in real time to add and delete certain individuals, choosing a geographic location and time and/or event for the group to meet, searching for or inviting other virtual groups, made up of individuals, sending invitations to those other virtual groups for a particular meeting or event, tracking and connecting with those other virtual groups, and rating the virtual groups or events. The present disclosure solves these and other disadvantage of the prior art systems.

### SUMMARY OF THE INVENTION

A system and method that improves on the prior art allows an individual or a group of individuals, through use of their cellular telephone, tablet or personal computer, to create or generate a virtual group or cliq of individuals, with the capability of adding and/or removing individuals from the virtual group. Further, in an exemplary embodiment, individuals in the group can ask to have other individuals added to, or removed from, the group. The group creator can invite those individuals to be in the group and has the authority to remove individuals from the group if asked or otherwise.

The group creator or the group as a whole can search for and/or choose an event, a geographic location and/or a time where the group will meet. The system also allows for a chat room between the group individuals to discuss adding other individuals, deciding on locations, or discussing any other subject. The group can search for other groups and review information about those groups or the individuals in those groups to see if there is a desire to meet with the group or some of the individuals of that other group. In an exemplary embodiment, the group can search for various events occurring in or near the group's geographic location, again to determine if the group wishes to attend the event. If there is a desire, the group can contact the other group or the event planner to request a meeting or inform the planner that the group will attend the event. Once accepted, the group can track the other group or get information about the event, including receiving notifications if the meeting, or any of the information, changes. Afterwards, the individuals in the group can provide related feedback or ratings, for example, about the group they met with or the event they attended.

A system that provides the above-noted advantages can include a processor and a database containing the program and information about the individuals in a group, group dynamics and group summary information, along with event information and ratings for the particular group and/or the events. In an exemplary embodiment, the processor may be included in a web server. The processor may be configured to execute instructions to provide a graphical user interface (GUI) to display visuals and accept information from users according to at least one of the group data and event data. The GUI can include an information portion and a search portion. The processor can be configured to display through the GUI related content from the group information portion and related event content. The processor may also be configured to display related review content during the search portion and display reviews and/or ratings for the other groups or events during the search portion. Such a system would allow for seamless, real time, integration from the group information to the search functions, thereby enhancing the group planning experience.

### BRIEF DESCRIPTION OF THE DRAWINGS

FIG. 1 is a block diagram view for an exemplary embodiment of a graphical user interface (GUI) for creating a virtual group of individuals in real time in accordance with the present disclosure.

FIG. 2 depicts an exemplary embodiment of a welcome page for an exemplary embodiment of a graphical user interface (GUI) for creating a virtual group of individuals in real time in accordance with the present disclosure.

FIG. 3 depicts an exemplary embodiment of an add members page for an exemplary embodiment of a graphical user interface (GUI) for creating a virtual group of individuals in real time in accordance with the present disclosure.

FIG. 4 depicts an exemplary embodiment of a choose the geographical location page for an exemplary embodiment of a graphical user interface (GUI) for creating a virtual group of individuals in real time in accordance with the present disclosure.

FIG. 5 depicts an exemplary embodiment of a group creation page for an exemplary embodiment of a graphical user interface (GUI) for creating a virtual group of individuals in real time in accordance with the present disclosure.

FIG. 6 depicts an exemplary embodiment of an invitation to the group page for an exemplary embodiment of a graphical user interface (GUI) for creating a virtual group of individuals in real time in accordance with the present disclosure.

FIG. 7 depicts an exemplary embodiment of a chat page for an exemplary embodiment of a graphical user interface (GUI) for creating a virtual group of individuals in real time in accordance with the present disclosure.

FIG. 8 depicts an exemplary embodiment of a search for another group page for an exemplary embodiment of a graphical user interface (GUI) for creating a virtual group of individuals in real time in accordance with the present disclosure.

FIG. 9 depicts an exemplary embodiment of a view other group information page for an exemplary embodiment of a graphical user interface (GUI) for creating a virtual group of individuals in real time in accordance with the present disclosure.

FIG. 10 depicts an exemplary embodiment of a suggest a group page for an exemplary embodiment of a graphical user interface (GUI) for creating a virtual group of individuals in real time in accordance with the present disclosure.

FIG. 11 depicts an exemplary embodiment of an invite another group page for an exemplary embodiment of a graphical user interface (GUI) for creating a virtual group of individuals in real time in accordance with the present disclosure.

FIG. 12 depicts an exemplary embodiment of a time and venue page for an exemplary embodiment of a graphical user interface (GUI) for creating a virtual group of individuals in real time in accordance with the present disclosure.

FIG. 13 depicts an exemplary embodiment of a notification page for an exemplary embodiment of a graphical user interface (GUI) for creating a virtual group of individuals in real time in accordance with the present disclosure.

FIG. 14 depicts an exemplary embodiment of a received invitation page for an exemplary embodiment of a graphical user interface (GUI) for creating a virtual group of individuals in real time in accordance with the present disclosure.

FIG. 15 depicts an exemplary embodiment of an invitation details page for an exemplary embodiment of a graphical user interface (GUI) for creating a virtual group of individuals in real time in accordance with the present disclosure.

FIG. 16 depicts an exemplary embodiment of a change meeting details page for an exemplary embodiment of a graphical user interface (GUI) for creating a virtual group of individuals in real time in accordance with the present disclosure.

FIG. 17 depicts an exemplary embodiment of an accepted meeting page for an exemplary embodiment of a graphical user interface (GUI) for creating a virtual group of individuals in real time in accordance with the present disclosure.

FIG. 18 depicts an exemplary embodiment of an alerts page for an exemplary embodiment of a graphical user interface (GUI) for creating a virtual group of individuals in real time in accordance with the present disclosure.

FIG. 19 depicts an exemplary embodiment of a rate the meeting page for an exemplary embodiment of a graphical user interface (GUI) for creating a virtual group of individuals in real time in accordance with the present disclosure.

### DETAILED DESCRIPTION

The present disclosure is a system and methods that allows a user to create, form or generate one or more virtual groups or “cliqs” of individuals in real time. Once the virtual group is generated, users can modify the group, set up a meeting location and time for the virtual group, among other functions, and then search to find other virtual groups that the virtual group is interested in meeting up with, or events that the virtual group wishes to attend. The present disclosure allows users to send and receive invitations to meet other groups at a particular geographic location and time or at an event.

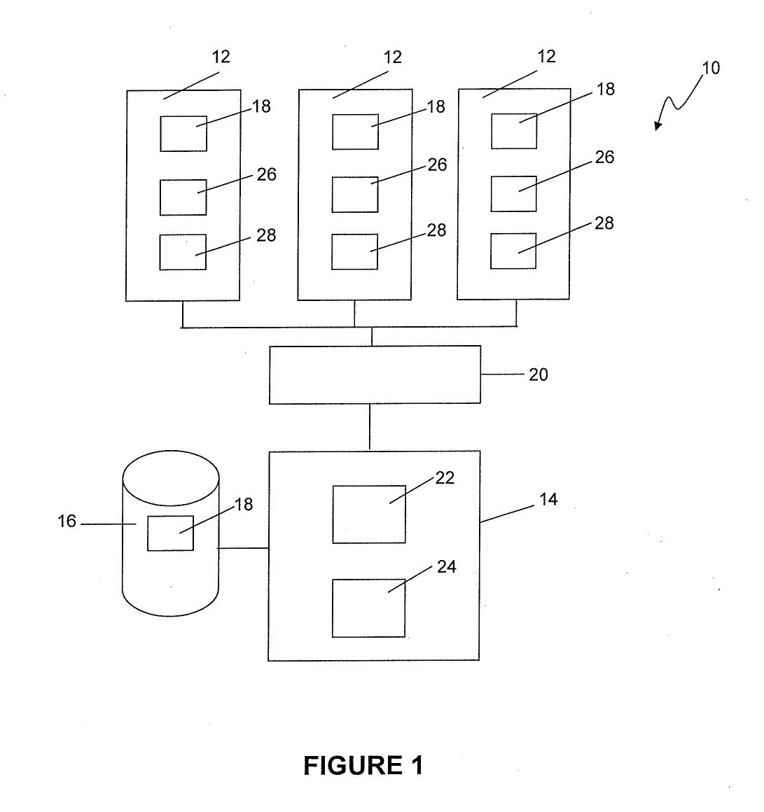

Referring to the drawings, wherein like reference numerals refer to the same or similar features in the various views, FIG. 1 is a block diagram view of an exemplary system 10 for generating a virtual group or group or cliq, and performing group functionality as described herein. The group generation system 10 may comprise a plurality of group user devices 12 (three such group user devices are illustrated in FIG. 1), such as cellular telephones, computer tablets or computer systems. The group generation system 10 also comprises a group data, event data, and support server 14 (which may be referred to herein as a group platform server 14), a group information database 16, a group generation and tracking application programming interface (“API”) 18, and a global communication network 20, such as a cellular or mobile network or the Internet, as known by those having ordinary skill in the art.

The group generation API 18 may be accessed, purchased, downloaded, etc. by users of the group user devices 12 to facilitate the generation, manipulation and tracking of the group or cliq as generated and described herein. Accordingly, the users may access the group generation API 18 directly (for example, through the group user devices 12) and/or indirectly (for example, through the group platform server 14), in embodiments. In the exemplary embodiment shown in FIG. 1, API 18 is shown in both the group user devices 12 and the group platform server 14, although portions of the API can be located in either or both.

In an exemplary embodiment, the group generation API 18 may facilitate the generation of a group of individuals, the adding or removing of individuals from the group, the determination of a meeting place (i.e., location and time), the searching for and locating other groups or cliqs and/or events, and the review or rating of a previous meeting and/or event, over the network 20 in real time (for example, by a user associated with an established group).

Accordingly, each of the group user devices 12 may be configured to provide access to a group generation platform 10 which may be or may include a group generation, manipulation and tracking application 18. As described herein, the group generation platform 10 may be operated by a user to, for example, create a new group, modify or manipulate an existing group, set up meeting time and place, search for other groups and review other groups or previous events, by utilizing the group generation API 18. The group generation platform (which may be referred to herein simply as “the platform”) may include and provide a graphical user interface (GUI) having a number of features described herein. Portions, or all, of the GUI may be provided by the group platform server 14, in an exemplary embodiment. Accordingly, in an exemplary embodiment, the group platform server 14 may be configured to perform one or more operations, methods, etc. described herein that enable various group functionality for a user.

The group platform server 14 may be configured to perform a number of functions to assist users in their group generation decisions. For example, the group platform server 14 may be configured to provide a list of individuals already in a particular group, a list of events occurring in the geographical area, and other information to users through the group user devices 12. This information and data may be obtained by the group platform server 14, in an exemplary embodiment, with the group generation API 18 and/or from the network 20.

The trading platform server 14 may be further configured to store data in and retrieve data from the group information database 16. Data stored in the group information database 16 may include information about a group, individuals in the group, events, ratings about the events, and similar information related to group generation that may be performed through the group generation platform 10.

The group information database 16 may be or may include one or more information repositories including, but not limited to, one or more databases and database types as well as data storage that may not necessarily be colloquially referred to as a “database.” As described herein, the database 16 may be configured to store, for example, information about various groups and group summaries, individuals in those groups, events, ratings of groups, ratings of events and similar related information created and/or obtained by or through the group generation API 18 through the trading platform 10.

The group platform server 14 may be in electronic communication with the group user devices 12 and with or through the network 20 to obtain group and meeting information and other information, in an exemplary embodiment. In exemplary embodiments, the group platform server 14 may be owned or operated by a particular entity, or there may be a number of entities that provide some of the services separately. Further, the group platform server 14 may be a single server, or multiple servers acting in a redundant or additive capacity.

In exemplary embodiments, the group user devices 12 may be configured to perform one or more of the functions described herein with reference to the group platform server 14. Accordingly, the group user devices 12 may be in direct electronic communication with the group information database 16, and/or the network 20.

The group platform server 14 may include a processor 22 and a memory 24. The processor 22 may be any appropriate processing device. The memory 24 may be any volatile or non-volatile computer-readable memory. The memory 24 may be configured to store instructions that embody one or more steps, methods, processes, and functions of the group platform server 14 described herein. The processor 22 may be configured to execute those instructions to perform one or more of the same steps, methods, processes, and functions.

Each of the group user devices 12 may also include a processor 26 and a memory 28, with three processors and three memories illustrated in FIG. 1. Each processor 26 may be any appropriate processing device. Each memory 28 may be any volatile or non-volatile computer-readable memory and may be configured to store instructions that embody one or more steps, methods, processes, and functions of the user or group user device 12 described herein. The processor 26 may be configured to execute those instructions to perform one or more of the same steps, methods, processes, and functions. One or more of the group user devices 12 may be or may include a personal computer or mobile device (e.g., tablet, smartphone), in an exemplary embodiment.

Instead of, or in addition to, a processor 22, 26 and memory 24, 28, the trading platform server 14 and/or one or more of the group user devices 12 may include a programmable logic device (PLD), application-specific integrated circuit (ASIC), or other suitable processing device (not shown).

As noted above, a user in the group generation system 10 may be provided with a platform for, among other things, the generation of one or more groups of individuals, the manipulation of the group, the tracking of the group and other groups and/or events, and the review of other groups and events. The platform may be provided, in an exemplary embodiment, by both the group user device 12 and the group platform server 14. That is, some elements or features of the platform may be installed on the group user device 12, and other elements or features of the group generation platform 10 may be provided by the group platform server 14 (for example, on a software-as-a-service (SaaS) basis). For example, the group user device 12 may provide or may have installed a program that includes a graphical user interface of the platform 10, and the group platform server 14 may provide much of the underlying data and analysis. However, storage and retrieval of data displayed in the platform, calculations performed by or under the platform, and services provided through the platform may be performed by one or both of the group user device 12 and the trading platform server 14.

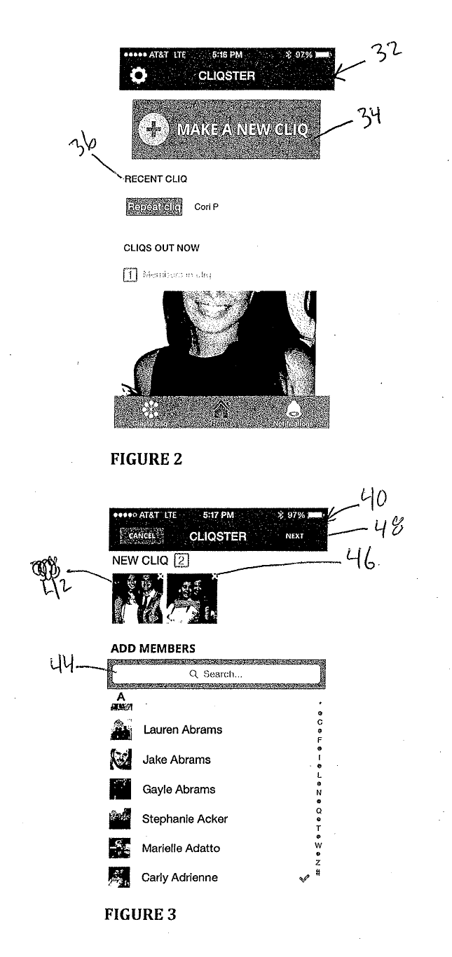

FIG. 2 is an exemplary embodiment of a welcome or a “Make a New Group” page 32. Once the user logs in, a group or cliq can be created by selecting the Make A New Cliq bar 34, or a previous group can be accessed 36. The group is a list of individuals that the creator of the group intends to go out with or meet with on a specific day or night. The New Group page 32 may serve as a central hub for users of the group generation platform 10. The new group page 32 may feature and highlight new or existing groups and from the New Group page 32, users may be able to navigate to other areas of the platform 10. For example, users may access functionality for adding individuals to or removing individuals from, a group, in an exemplary embodiment.

FIG. 3 is an exemplary embodiment of an “Add Members” page 40. The user can review the individuals in the group 42, use the search bar or scroll function 44 to find and invite friends to be in the group. Among numerous other ways, friends can be accessed through social media, such as Facebook or Instagram. Users can remove individuals, for example, by pressing the “X” 46 located in the top right corner of the individual's picture. To move to the next page, select “Next” 48.

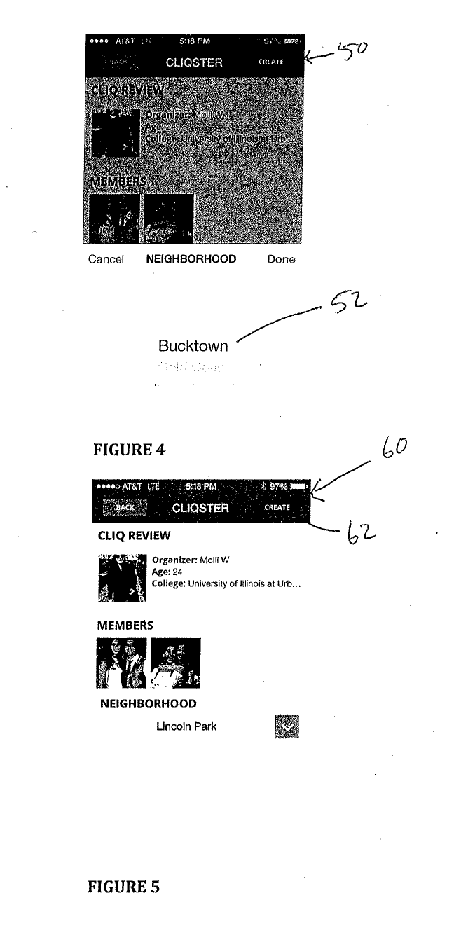

FIG. 4 is an exemplary embodiment of a “Choose a Desired Neighborhood” page 50. Once the group has been created, the user can choose a preferred neighborhood by using the drop down menu 52 to scroll through the neighborhoods and select the most appealing. Further, in an exemplary embodiment, the user can access a list of neighborhoods 52 or events for a meeting using a search function or social media, as understood by one having ordinary skill in the art.

FIG. 5 is an exemplary embodiment of a “Create your Cliq” page 60. On this page 60, the user can review the group or cliq, the individuals that make up the group, and the desired neighborhood (or event). Once the review is complete and the user is ready, the user can select the “Create” button 62 to create the group.

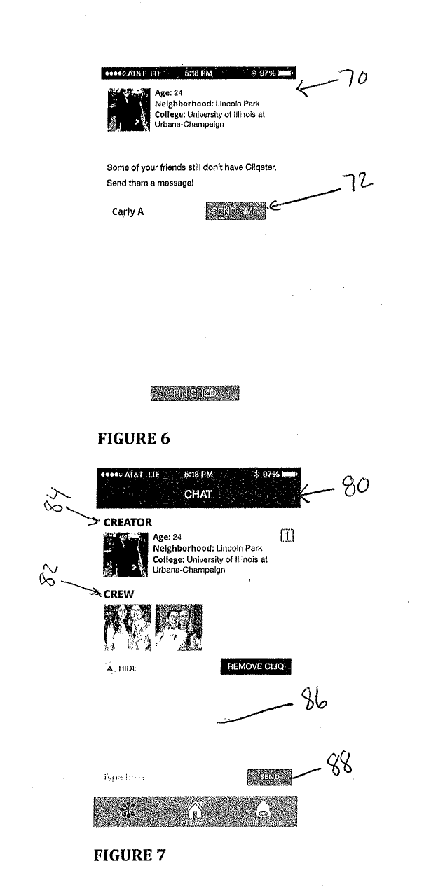

FIG. 6 is an exemplary embodiment of an “Invite Friends to Download Cliqster” page 70. At this page 70, the user can notify individuals to download the software program or application, if they have not already done so. The platform 10 will send an invite, for example, an SMS 72, requesting them to download the application.

FIG. 7 is an exemplary embodiment of a “Chat” page 80. Information about the group 82 and the creator 84 can be seen on the page 80. Further, the user can chat with other individuals in the group by entering text into the chat box 86 and selecting the send button 88.

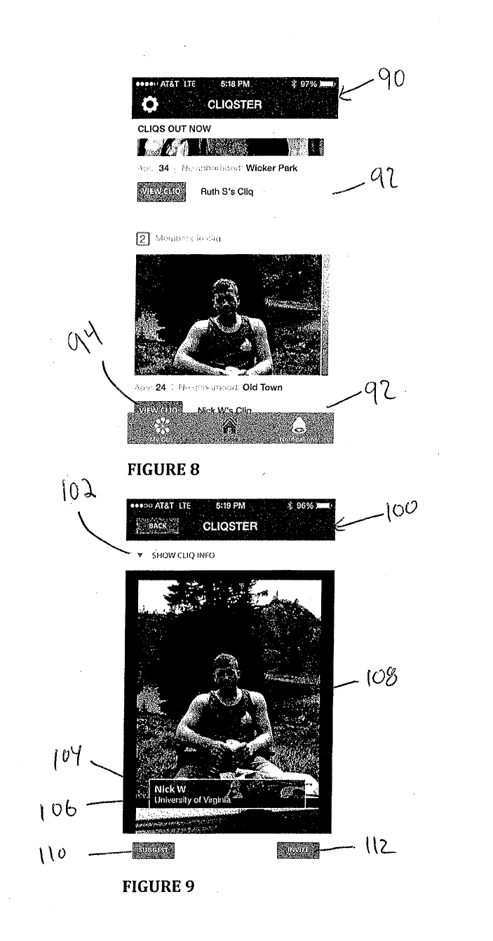

FIG. 8 is an exemplary embodiment of a “Find an Interesting Cliq” page 90. The user can scroll through the screen to find multiple groups or cliqs 92, some of which may be of interest to the user and the user's group. Upon finding another group, the user can then select the “View Cliq” button 94 to learn more about the group, such as how many individuals are in the group, their ages, photos and the neighborhood they have chosen.

FIG. 9 is an exemplary embodiment of a “View the Cliq in Detail” page 100. The user selects the “Show Cliq Info” button 102 to scroll through each individual of the other group and their information, including name 104, school 106, photos 108, etc. In an exemplary embodiment, the platform 10 may also inform the user of other information, such as age, hobbies, interests, etc. The user can select the “Suggest” button 110 to send a message to the user's group to suggest the other individuals to review the suggested group's details. The user can also select the “Invite” button 112 to invite the other group to a meeting or event.

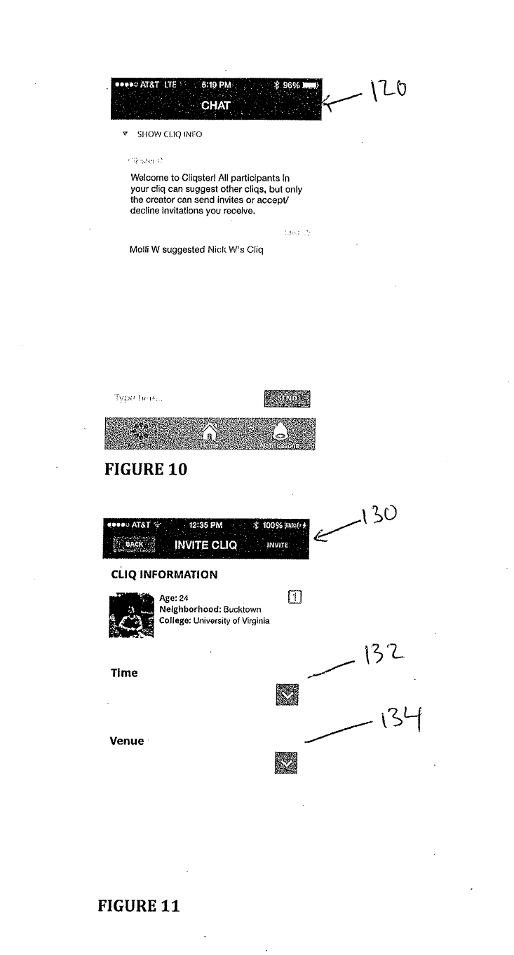

FIG. 10 is an exemplary embodiment of the “Chat” page 120. By selecting the “Suggest” button 110, a hyperlinked message is sent to the members of the user's group to review. The platform 10 will allow the group members to view the details as the suggesting user had reviewed, prior to suggesting. In an exemplary embodiment, this information can be displayed and discussed in the chat room 120.

FIG. 11 is an embodiment of an “Invite Cliq” page 130. Once the user or the group has decided on another group to meet with, the platform 10 allows the user to invite the other group (selecting Invite button 112) to meet the user's group by inserting a time 132 and a place 134.

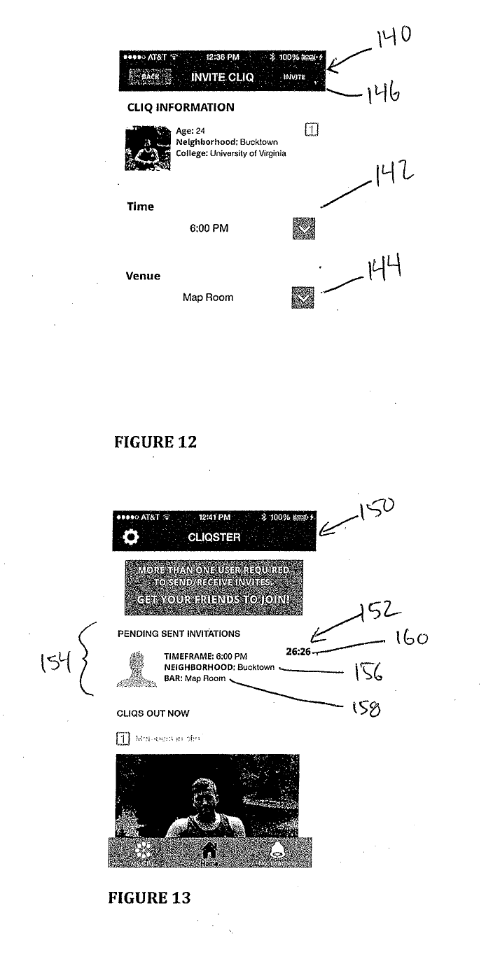

FIG. 12 is an exemplary embodiment of an additional “Invite Cliq” page 140. The user can scroll through and choose a time 142 and a venue 144 to meet. The meet venue 144 choices will be based on where the invited cliq has chosen to go. The user can select the “Invite” button 146 to send an invitation to the chosen group or cliq.

FIG. 13 is an exemplary embodiment of a wait for a response page 150. The platform 10 will send an invitation 152 to the invited cliq, who will receive the notification that your cliq has invited them to meet. The invitation will include the details 154 of the requested meet time, including neighborhood 156 and venue 158. In an exemplary embodiment, the invited cliq has a certain amount of time 160 to respond “Yes” or “No” to your meet up invitation 152.

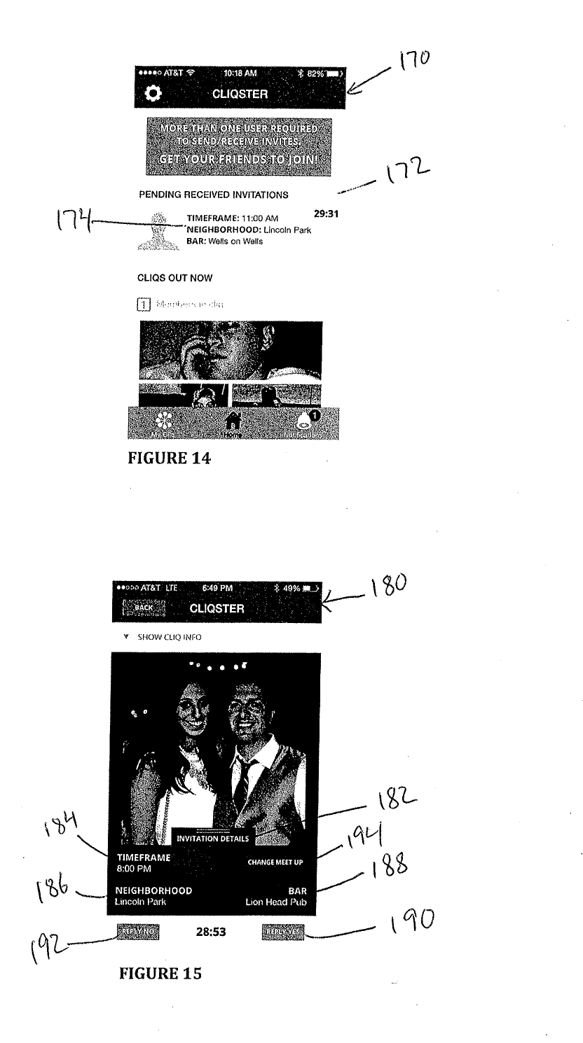

FIG. 14 is an exemplary embodiment of a receive an invite to meet up page 170.

If a group receives an invitation from another group or cliq to meet up, that group will see the pending received invitation 172 on the screen of the platform. By selecting the pending invitation 172 on the display, the group members can view the invitation details 174.

FIG. 15 is an exemplary embodiment of an “Invitation Details” page 180. When a group is invited to meet, the group members can view the invitation details 182, which include the time 184, neighborhood 186, and the venue 188, such as a bar, of the potential meet up. The group can reply “Yes” by selecting the “Reply Yes” button 190, or reply “No” by selecting the “Reply No” button 192 to the invitation. A Reply of no will allow the member to continue to search for a suitable cliq. By replying yes, a transmission will be sent to the inviting group pertaining to the upcoming meet up. In an exemplary embodiment, once yes is replied, previous functionality of the application will be disabled. The invited group can also change the meet up information, if the requested time or place is not acceptable, by selecting the “Change Meet Up” button 194.

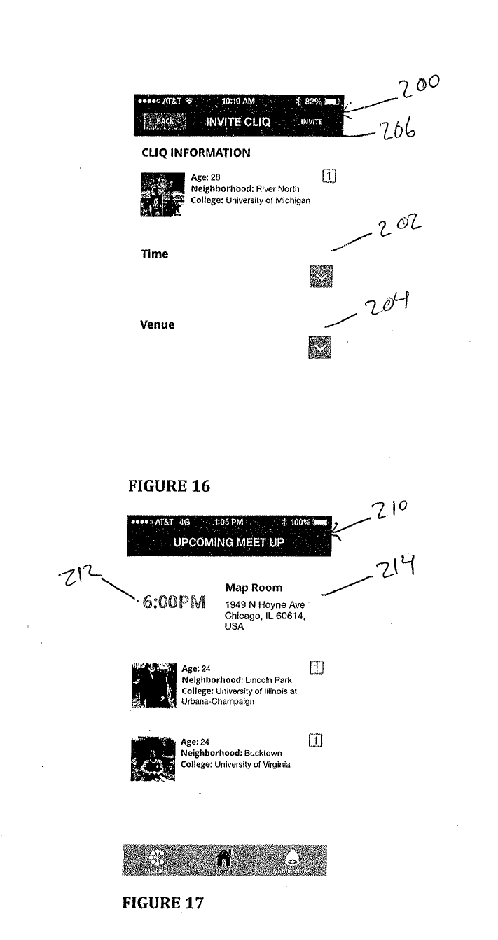

FIG. 16 is an exemplary embodiment of a change meet up details” page 200. If the user selects “Change Meet Up” button 194 on the Invitation Details page 180 (FIG. 15), the platform 10 will display and allow the invited group to change the meet up details. The user can change the time 202 and/or venue 204 of the potential meet up. Once the changes have been made, the user can select the “Invite” button 206, thereby altering the time 202 and/or place 204 of the meeting.

FIG. 17 is an exemplary embodiment of a “Upcoming Meet Up” page 210. When an invited cliq responds “Yes” to an invitation, or when the user's group responds “Yes” to an invitation, both groups will see the “Upcoming Meet Up” page 180 on their displays. The display details the time 212 and location 214 of the meet up. In an exemplary embodiment, all other functionality of the application is disabled when you have a confirmed meet up.

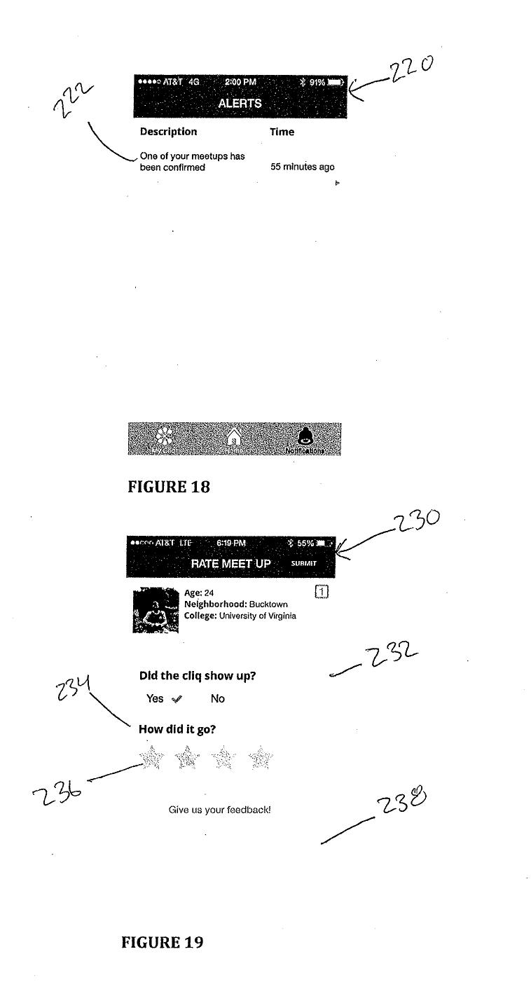

FIG. 18 is an exemplary embodiment of a “Alerts” page 220. The group can receive alerts when it is invited to join a group or cliq, when one of the group's invitation has been confirmed 222 or rejected, when the group receives an invite to meet up, and when the group's invitation to meet up has been changed.

FIG. 19 is an exemplary embodiment of a “Rate Meet Up” page 230. After going to a meet up, in an exemplary embodiment, the next time the members open the application, they will be prompted with the Rate Meet Up page 200. The members can answer whether or not the group showed up 232, and rate the overall experience 234 with one to five stars 236. The members can also submit written feedback 238.

As described above, the platform 10 comprises a system and methods for creating, forming or generating one or more virtual groups of individuals, comprising information such as individuals' names, age, pictures, schools, hobbies, interest, etc. The platform 10 allows the group to be updated or revised by adding and removing individuals in real time or updating information about the groups or the individuals. The platform 10 can assist in searching for and locating other virtual groups of individuals and/or events, using venues, geographical locations, such as neighborhoods, and time. Then the platform allows one group to connect with other virtual groups and invite those groups to meet up or accept invitations from other group to meet up. The platform also allows the group members to review and/or rate the groups that they met with or the events they attended, all in real time and using individual user devices, such as, cellular telephones, computer tablets or personal computers.

Various exemplary embodiments are described herein to various apparatuses, systems, and/or methods. Numerous specific details are set forth to provide a thorough understanding of the overall structure, function, manufacture, and use of the exemplary embodiments as described in the specification and illustrated in the accompanying drawings. It will be understood by those skilled in the art, however, that the exemplary embodiments may be practiced without such specific details. In other instances, well-known operations, components, and elements have not been described in detail so as not to obscure the exemplary embodiments described in the specification. Those of ordinary skill in the art will understand that the exemplary embodiments described and illustrated herein are non-limiting examples, and thus it can be appreciated that the specific structural and functional details disclosed herein may be representative and do not necessarily limit the scope of the exemplary embodiments, the scope of which is defined solely by the appended claims.

Reference throughout the specification to “various exemplary embodiments,” “some exemplary embodiments,” “one exemplary embodiment,” or “an exemplary embodiment”, or the like, means that a particular feature, structure, or characteristic described in connection with the exemplary embodiment is included in at least one exemplary embodiment. Thus, appearances of the phrases “in various exemplary embodiments,” “in some exemplary embodiments,” “in one exemplary embodiment,” or “in an exemplary embodiment”, or the like, in places throughout the specification are not necessarily all referring to the same exemplary embodiment. Furthermore, the particular features, structures, or characteristics may be combined in any suitable manner in one or more exemplary embodiments. Thus, the particular features, structures, or characteristics illustrated or described in connection with one exemplary embodiment may be combined, in whole or in part, with the features structures, or characteristics of one or more other exemplary embodiments without limitation given that such combination is not illogical or non-functional.

Although a number of exemplary embodiments have been described above with a certain degree of particularity, those skilled in the art could make numerous alterations to the disclosed exemplary embodiments without departing from the spirit or scope of this disclosure. For example, all joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. It is intended that all matter contained in the above description or shown in the accompanying drawings shall be interpreted as illustrative only and not limiting. Changes in detail or structure may be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A method of creating and upgrading a virtual group of individuals in real time, the steps comprising:
providing for the determination of a first selected group of individuals, said first selected group of individuals made up of one or more individuals, said first selected group of individuals comprising information about the one or more individuals;
providing for the updating of the first selected group of individuals;
allowing for the searching of a plurality of groups of individuals, each of said plurality of groups of individuals comprising information about individuals in each of said plurality of groups of individuals;
allowing for the selecting of a second selected group from said plurality of groups of individuals;
allowing for the searching of a plurality of events;
allowing for the selecting of a first selected event from said plurality of events;
allowing for the notifying of said second selected group of said first selected event.

2. The method of claim 1, wherein said information about the one or more individuals comprises the number of individuals in the selected group, the ages of the individuals in the selected group; pictures of the individuals in the selected group, and the events that a selected group of individuals has chosen.

3. The method of claim 1, wherein said updating of the first selected group of individuals comprises adding new individuals to said first selected group of individuals.

4. The method of claim 1, wherein said updating of the first selected group of individuals comprises removing individuals from said first selected group of individuals.

5. The method of claim 1, further comprising the step of allowing for the inviting of additional individuals to become part of the first selected group of individuals.

6. The method of claim 5, wherein the step of inviting of additional individuals to become part of the first selected group of individuals comprises accessing said additional individuals through social media.

7. The method of claim 1, further comprising the step of allowing individuals in said first selected group of individuals to chat with other individuals in said first selected group of individuals.

8. The method of claim 1, further comprising the step of allowing individuals in said first selected group of individuals to text with other individuals in said first selected group of individuals.

9. The method of claim 1, wherein each of said plurality of events comprises a venue, geographical location and a time.

10. The method of claim 1, wherein notifying of said second selected group of said first selected event comprises informing said second selected group of said venue, location and time of said first selected event.

11. The method of claim 10, further comprising allowing said second selected group to confirm that it will meet said first selected group at the venue, geographic location and time for the first selected event.

12. The method of claim 1, further comprising:
allowing said second selected group to revise the first selected event to a second selected event, said second selected event having at least one different venue, geographic location or time then said first selected event.

13. The method of claim 1, further comprising:
sending alerts to each of the individuals of the first selected group and the second selected group pertaining to the first selected event.

14. The method of claim 13, wherein said alerts notifying the individuals of the first selected group and the second selected group of the venue, geographic location and time of said first selected event.

15. The method of claim 13, wherein said alerts notifying the individuals of the first selected group and the second selected group that they will not meet at the venue, geographic location and time of said first selected event.

16. The method of claim 1, further comprising:
allowing said first selected group to review said second selected group, wherein allowing said first selected group to review said second selected group comprises rating the second selected group.

17. The method of claim 16, wherein rating the second selected group comprises rating one or more of the individuals from the second selected group.

18. The method of claim 1, further comprising:
allowing said first selected group to review said first selected event, wherein allowing said first selected group to review said first selected event comprises rating the first selected event.
